(19) United States
(12) Patent Application Publication
(10) Pub. No.: US 2016/0153426 A1
(43) Pub. Date: Jun. 2, 2016

(54) BEARING AND GEAR UNIT FOR WIND TURBINES

(71) Applicant: Jens GROENAGER, Ranum (DK)

(72) Inventor: Jens GROENAGER, Ranum (DK)

(21) Appl. No.: 14/902,567

(22) PCT Filed: Jul. 4, 2013
(86) PCT No.: PCT/DK2013/000046

§ 371 Date: Jan. 2, 2016

(51) Int. Cl. F03D 11/02; F16H 3/30

(52) U.S. Cl. CPC F03D 11/0008

(57) ABSTRACT

The economic efficiency of wind turbines improves by upscaling but the weight to strength ratio deteriorates. This is especially true for the large shaft and bearing of the rotor, the gearbox and the generator. Solutions to this was the gearless generator, getting heavy because the amount of magnetic material is inversely proportional to speed, or several smaller generators adapted to the wind on a distribution gear as shown in references (1), (2) and (3). The large roller bearing of the rotor has relatively large bearing clearance so only the top or lower rollers bear the entire weight of the rotor and thus must be dimensioned relatively large. The present invention spreads the load on the support bearing to more rollers and to smaller faster running and thereby lighter generators. It has the rotor attached to the outer ring, each roller rotatably mounted to the nacelle and the inner ring free wheeling. The outer and inner rings are relatively stiffer than the rotatable fixation of the upper rollers to the nacelle, so that the upper rollers flex slightly down under the weight of the rotor allowing some of the force of gravity to be transferred to the inner ring and on to the bottom relatively stiff journalled rollers. Gear teeth can be used to transfer torque to all rollers, or the inner ring pressed against the side rollers, or the conical rollers can be pressed dynamically in between the outer and inner ring with relatively constant force. This is shown in FIGS. 1 and 6 in perspective and FIG. 2 and FIG. 3, in radial section. The relatively small roller shafts can now be used as PTO with gear ratio bearing diameter to roller diameter. The cost of the extra bearings for each roller is offset by savings in the usual center shaft and gear. Also, the friction from the edge of the outer or inner ring to keep the large rollers in place is missing. These benefits are especially important for wind turbines with heavy hub, axle and gear on a tall tower, and large wing rotor bearing clearance causing inappropriate vibrations of the long components. With no central hub shaft, gear and generator in the nacelle center there is space for force carrying structures as strong as the top of the tower to a point on the centre line of the rotor in front of it. To this a bearing for sustaining the varying moments of the wind can be affixed so the weight carrying bearing and gear unit can be designed cylindrical; or stays can be continued to other tower elements achieving a tower structure with significantly lower weight and higher natural frequency than usual wind moment influenced single column towers.

### BACKGROUND OF THE INVENTION

Concurrent with wind turbines scaling up to MW class the weight of the nacelle has gone from approximately twice the rotor weight to triple or quadruple. This because the mass forces in the cube of the wing length dominates over the wind forces in the second power thereof. The relatively large components in the nacelle, that must sustain these forces also have a comparatively poorer weight to strength ratio. For example, the weight of the large massive hub shaft is proportional to the cube of its radius while forces are mainly absorbed in its surface proportional to the square thereof. The same conditions apply to the large central input gear wheel that also predominantly absorbs forces in its periphery thus not utilizing its central mass. Consequently there is an opportunity to save mass, which in prior art was just there; not used for resisting forces and amounted to roughly a quarter of the nacelle weight. The purpose of the present invention is therefore to save about one half of said non force resisting mass that is about 10% by weight of the nacelle. Maybe not a large number, but it may have relatively large significance moving the natural frequency of the tower-nacelle above the excitation from the wings.

### PRIOR ART

Gearless wind turbines with multipole generators on the rotor shaft is prior art. The complexity of many poles and a large amount of heavy magnetic material is needed to compensate for the low speed range, but the weight and complexity of the central gear unit is saved.

### SUMMARY OF THE INVENTION

The combined bearing and gear unit according to the invention also saves the central rotor shaft as PTO from the individual rollers of the only remaining bearing provide the equivalent of traditional first-stage gearing. One embodiment is to attach many relatively small mass-produced generators, one on each PTO to facilitate the many poles relatively inexpensively. If the bearings 6 and 7 of FIGS. 1 to 6 for the individual roller shafts are firmly rooted in the nacelle the upper quarter must be able to support the whole weight of the rotor attached to the outer ring 2. Otherwise, a free counter-rotating inner ring as shown in FIG. 6, can transfer half of this weight to the lower rollers when the rollers are fixated to the nacelle with a smaller stiffness than the stiffness of the inner ring. Alternatively, a fixed inner ring can support the total weight of the rotor so that the bearings 6 and 7 between the rings 1 and 2 of FIG. 1 only have to resist the outward pressing force from the conical rollers. A drawback of this embodiment is that the power must then be transmitted via slip rings because the assembly of rollers between the rings rotate at half speed and the gearing is also half of the aforementioned alternatives.

The problem of uneven transfer of power and rotor weight to rollers distant from the top can also be reduced by springs pushing them tighter into the space between the inner and outer ring in positions below the top. And reduced even more if it is an active push in the axial direction of each roller controlled by actuators. The cost of these is outweighed by longer bearing life from constant load, less bearing wear and higher performance due to the lower bearing friction that can be dynamically lowered at the frequent low wind speeds, where the demands on the bearing support of wind shear loads are smaller. Under these conditions the friction is least if the lower rollers are not squeezed in between the rings and thus do not get friction forces transmitted to the bottom generators or motors, so that they are coupled off the power output. Conversely the load carrying top rollers are most compressed, thereby rotating quicker with the greatest friction force with most power output potential, which fits fairly well with common electrical characteristics of generators.

The changing forces of the wind can be absorbed by having opposed pairs of rollers in the opposing conical surfaces between inner and outer ring from either side.

One embodiment has generators mounted on the individual roller shafts outside of the rings as shown in FIG. 3, so that this bearing and gear unit replaces the usual rotor shaft with associated bearings, central gear and generator in wind turbines. For a 7 MW turbine, this requires a Ø 15 m bearing unit in order to have sufficient friction on the rollers to transfer the total torque. In another embodiment the outer conical end of the rollers are provided with teeth similar to planet gears so that the friction is not a limiting factor, whereby the diameter of the bearing unit comes down to 8 m. A third embodiment shown in FIG. 3 has yet another planetary gear stage succeeding this, and the permanent magnet generators offset each other shown FIG. 5, whereby the bearing unit diameter comes down to 5 m. As shown in Annex 2 the smaller rollers however increases the friction loss from approximately 8% for the large diameter 15 m bearing to 9% and 10% respectively for the smaller ones.

It is also possible to have teeth on only some of the rollers with freewheeling gear wheels between these to transmit power to a central generator shown in FIG. 6. When the wind increases the necessary frictional force similarly increases by the outer ring being pressed up against the rollers sufficiently small cone angle, as calculated in Annex 2 and the sprockets teeth can be successively wider going up to the central wheel 11 to achieve constant loads with least weight.

A fourth embodiment has motors fitted to the individual rotor shafts outside of the rings with spring- or actuator pretensioned bearings, so that this bearing and gear unit replaces the yaw turntable with associated motors and brakes for the nacelle or pitch turntable for individual wings in wind turbines.

### BRIEF DESCRIPTION OF THE DRAWINGS

FIG. 1 shows the bearing and gear unit in 3D perspective.

FIG. 2 is a section of 1 showing rollers and their bearings in detail.

FIG. 3 elaborates FIG. 2 with another gear stage and generator.

FIG. 4 is a detailed axially symmetric view of FIG. 3

FIG. 5 shows gears and generators offset, tightly spaced.

FIG. 6 show rollers and gears supported by a freewheeling inner ring.

### DETAILED DESCRIPTION OF THE PREFERRED EMBODIMENTS

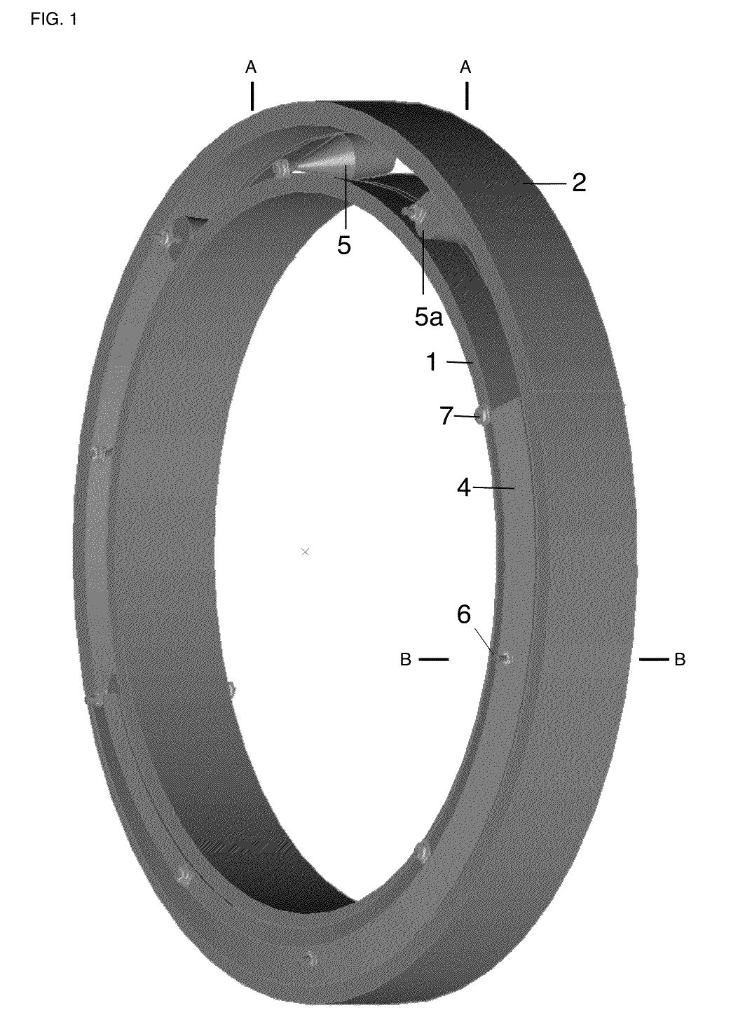

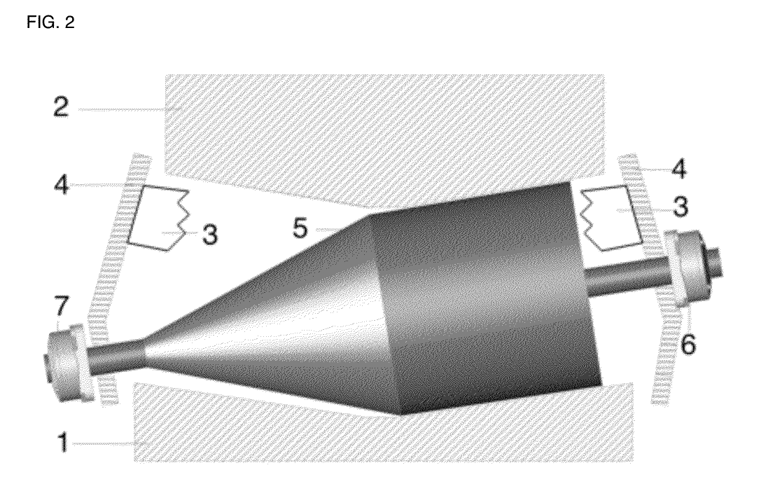

In FIGS. 1, 1 and 2 are the inner and outer ring where 1 for a 7MW turbine has a distance of two and a half meters to the bearing center axis in the direction of the wind. 4 is the intermediate ring spacer to which the rollers 5 are attached with bearings 6 and 7.

FIG. 2 is the corresponding radial section along A-A of FIG. 1 where also a part of the load bearing connection 3 between the two opposed portions of the spacer ring 4 is shown behind roller 5

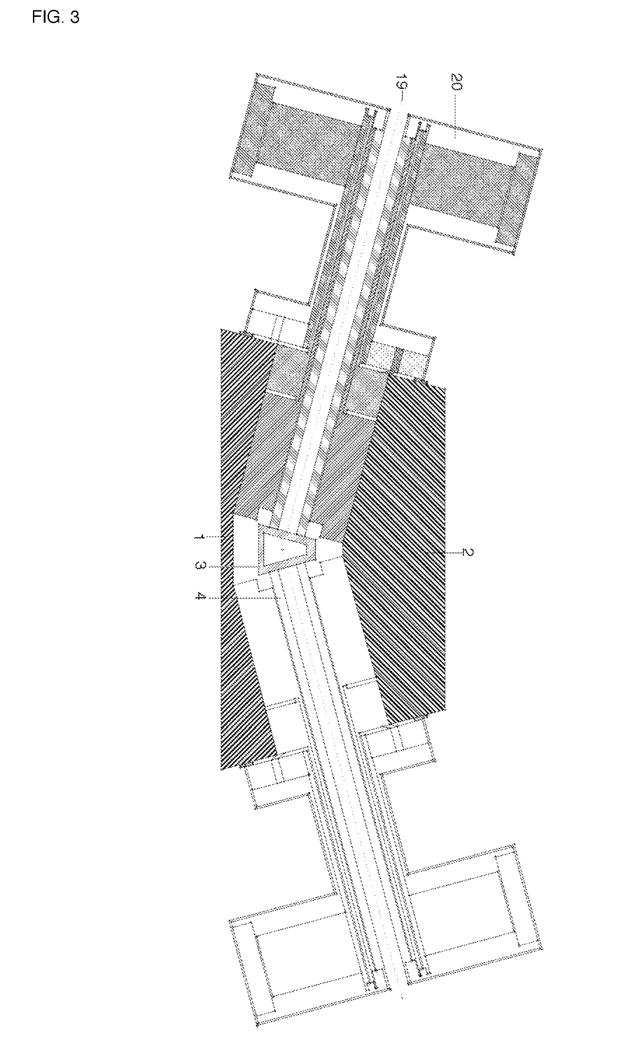

In FIG. 3, the load bearing connection 3 is formed as a central freewheeling ring between rings 1 and 2 to which the shafts 4 of the opposing rollers, gears and generators 20 are rigidly fixed.

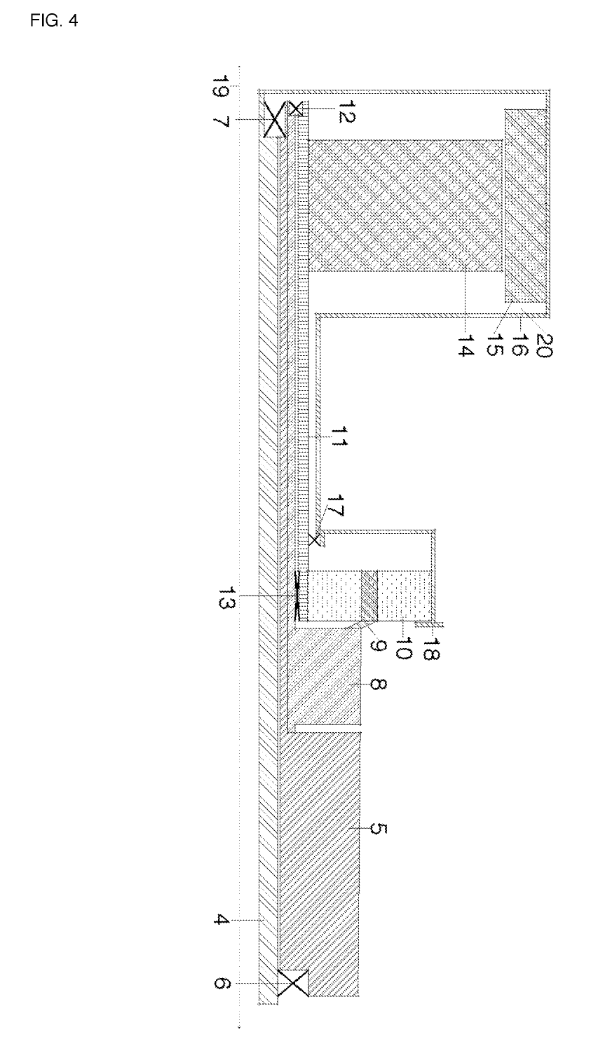

FIG. 4 shows a rotationally symmetric section through two opposing roller gear generator units 20 along their axis of symmetry 19. The axial roller bearing 7 supplies the necessary back pressure for the conical roller 5, whose second support is the bearing 6. Concentric with the left extension of 5 with the same shading the planet gear 8 may turn slightly compared to 5

The planet gear 8 is in engagement with the teeth on the outer ring 2 and possibly also the inner ring 1 (in this case corresponding to a sun gear), and has the same taper mesh circle as the conical roller 5. If the manufacturing accuracy was ideal there would be no need for the loose very slowly rotating fit between 5 and 8, because they would rotate at the same speed.

The teeth are really only needed for a 7MW turbine when the inner ring diameter is less than 15 meters, which would otherwise allow the transfer of the total torque using a traction oil with friction coefficient of 0.1 as shown in Annex 1.

From the planet wheel 8 extends one or more shafts 9 to the next stage planetary gear wheel 10 which is in engagement with the toothing of the outer ring 16 and the sun gear 11. This is journalled in a needle bearing 13 just below the planetary wheel and a ball bearing 12 at the other end. Affixed on the sun gear 11 is the generator rotor 14, while its stator 15 is fixed to the outer cover 16, whose left end is rigidly secured to the roller shaft 4 while the other is supported radially by a bearing 17 on the central shaft of the sun gear 11

The outer cover 16 which in some embodiments rotates at half the speed of the outer ring 2 fits close against this and the inner ring with fx a labyrinth seal 18 which allows an oil bath around the planet wheels 10 and 8. An additional oil reservoir can be established in the outer ring 2 or behind the bearings 7 and 12.

In the embodiment where the outer cover with the stator rotates relative to the inner ring, it is necessary to transfer the power using slip rings. However, it is enough with slip rings on one side of the bearing-gear unit as the current from the generators of the other side can be passed through the hollow roller shafts 4.

Each of the 72 one hundred kilowatt roller, gear and generator units 20 required for a 7 MW turbine can be fabricated and assembled as separate entities. These units are mounted between the free-hanging outer 2 and inner ring 1 by bolting their central shaft 4 to the cage ring holder 3 from both sides. This provides for establishing a predefined bearing clearance which can be restored by tightening after bearing wear. Hereby the extra wear and tear is avoided of conventional large bearings from the edges of the hole for inserting rollers as well as the roller's friction against the edge of the outer or inner ring necessary to keep the rollers in place.

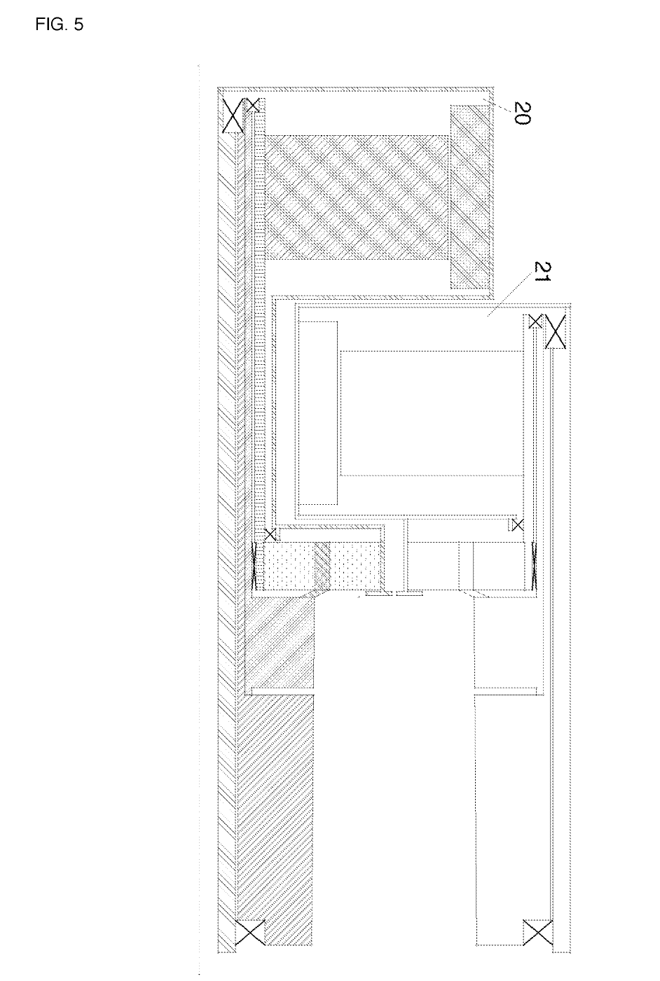

FIG. 5 along the section B-B of FIG. 1 shows how a shorter version of the roller, gear and generator unit 21 can be mounted in the constriction of the outer cover 16 of 20 with a minimal gap between them providing for a compact design. To make room for 36 generators for a 7 MW turbine on one side of a 5 m diameter bearing and gear unit it is necessary to make this constriction of the outer cover between 16 and 17 for every second generator to be seated herein closer to the rotor bearing.

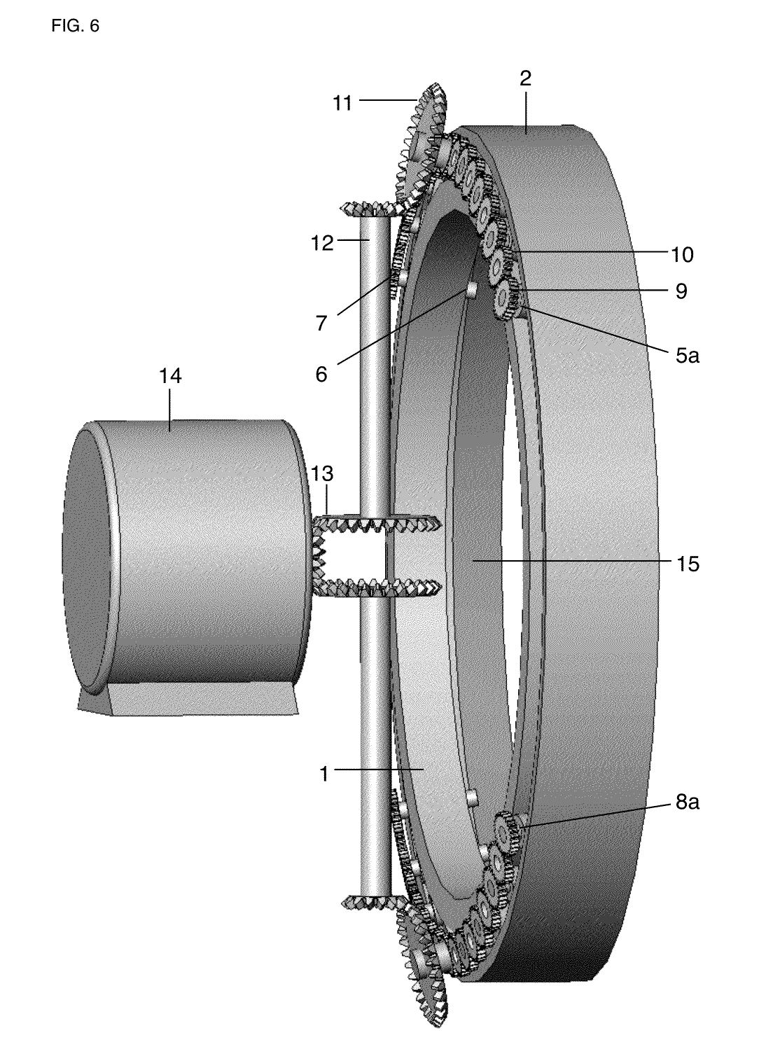

FIG. 6 shows how the free wheeling inner ring 1 transmits forces from the outer ring 2 on the upper rollers 5a to the bottom rollers 8a. The inner ring supports only the rollers that feel increased force when the wind from the right increases, and they are rotatably fixated to the nacelle by bearings on both sides of the inner ring at positions 6 and 7. There are only weight supporting rollers on the upper respectively lower quarter and they transfer power to each other via the attached gear 9 to the intermediate gear 10 and last to the central upper respectively lower gear 11. The last two can then transfer the geared power via two vertical shafts 12 to a central bevel gear 13 on a central generator 14. They rollers necessary for preventing yaw and pitch of the outer ring are not shown, but they are fitted like the rollers 5 in FIG. 1 in four equally spaced positions on the right inner conical surface of the outer ring 15.

What is claimed is:

1. Bearing and gear unit for a wind turbine consisting of an outer ring on which the rotor is mounted and a plurality of rollers connected to a generator or motor, characterized in that the rolling elements are rotatably attached to the nacelle and carries the outer ring.

2. Bearing and gear unit for a wind turbine according to claim 1, characterized in that the upper rollers are mounted inside the outer ring, while the bottom rollers are mounted outside and thus bear some of the weight of the outer ring and the rotor from the outside.

3. Bearing and gear unit for a wind turbine according to claim 1 or 2 characterized in that the rolling members are supported by an inner ring from the inside.

4. Bearing and gear unit for a wind turbine according to claim 1, 2 or 3 characterized in that the rolling elements are fixed to the nacelle with varying stiffness.

5. Bearing and gear unit for a wind turbine consisting of an outer ring mounted on the rotor and a plurality of rollers connected to the generator or motor, characterized in that the rolling elements are rotatably attached to a common spacer for all rollers which rotate at half the speed of the outer ring around an inner ring fixed to the nacelle.

6. Bearing and gear unit for a wind turbine according to claim 5 characterized in that the rolling elements are tightened by actuators pushing them further or less into the space between the inner and outer ring.

7. Bearing and gear unit for a wind turbine according to claim 1, 2 or 3 characterized in that a number of rolling elements are connected to the same generator or motor and the unsymmetrical moment of the wind is supported by a second bearing on the axis of symmetry of the outer ring.

8. Bearing and gear unit for a wind turbine according to claim 1,2, 3 or 4 characterized in that a number of rolling elements are connected to the same generator or motor, and the bending moments of the wind is supported by other angled rolling members against the outer ring.

9. Bearing and gear unit for a wind turbine according to claim 1 or 5, characterized in that the generators or motors are mounted staggered on successive rollers as shown in FIG. 5

10. Bearing and gear unit for a wind turbine according to claim 1 or 5 characterized in that the first stage gear wheel for a single rolling element is mounted rotatably relative to the centre shaft of the rolling element.
